(19) United States
(12) Patent Application Publication
(10) Pub. No.: US 2010/0089193 A1
(43) Pub. Date: Apr. 15, 2010

(54) PROPULSION MECHANISM WTIH TWO INDEPENDENT ACTUATORS

(76) Inventor: Joel Martin, Aix-en-Provence (FR)

Correspondence Address: SUGHRUE MION, PLLC, 2100 PENNSYLVANIA AVENUE, N.W., SUITE 800, WASHINGTON, DC, 20037, US

(21) Appl. No.: 12/594,658

(22) PCT Filed: Apr. 1, 2008
(86) PCT No.: PCT/FR08/00442

§ 371 Date: Nov. 25, 2009

(30) Foreign Application Priority Data
Apr. 3, 2007 (FR) 0702420

(51) Int. Cl. B62M 1/00; B62M 9/10; B62M 9/02; B62M 1/02; F16H 57/00; B62M 1/04; B62M 11/00; B62M 3/00; B63H 16/18; B63H 16/20; F16H 29/00; F16H 29/02; F16H 29/12

(52) U.S. Cl. 74/404; 74/594.1; 474/69; 74/405

(57) ABSTRACT

The present invention relates to a propulsion mechanism provided with two independent actuators, the first actuator being connected via a first connection member CD to a first converter ED, RLD mounted on a transmission shaft AT. Further, the second actuator is connected via a second connection member CG to a second converter EG, RLG mounted on the same transmission shaft AT.

The present invention relates to a propulsion mechanism provided with two independent actuators.

This mechanism is supplied with muscle energy and is suitable for propelling any type of vehicle by manpower, whether over ground, over sea, or in the air. Thus, it relates to bicycles or tricycles for driving one or more wheels, boats for driving a paddle wheel (pedalos) or a screw propeller, and aircraft for driving a propeller.

Known propulsion mechanisms comprise two actuators, each connected via a connection member to a converter mounted on a transmission shaft.

In the most widespread configuration, the actuators are pedals, the connection members are cranks, and the converter is a sprocket plate mounted on a transmission shaft.

If, for example, the vehicle is a bicycle, that arrangement corresponds to the pedals and the bottom bracket bearing assembly (pedal assembly).

In a pedal assembly, the two pedals are rigidly connected to the sprocket plate, and so their movements are necessarily synchronized.

That solution is suitable when the forces applied to the two pedals are identical, but that is not always the case. A cyclist does not necessarily have the same force in both legs. Further, one leg may have a handicap that is permanent or temporary, for example a sprain.

Thus, in a first aspect, the present invention aims to provide a propulsion mechanism that can take into account a lack of symmetry in the forces applied to the two actuators.

According to the invention, the propulsion mechanism comprising a first actuator is connected via a first connection member to a first converter mounted on a transmission shaft; it further comprises a second actuator that is connected via a second connection member to a second converter mounted on said transmission shaft.

This means that the two actuators contribute to driving the transmission shaft independently of each other.

Generally, this mechanism is provided to drive a propulsion shaft and if necessary, this mechanism includes a conversion module:
to reverse the direction of rotation of said propulsion shaft relative to that of the transmission shaft; and/or
to modify the ratio of the rotational speeds of this propulsion shaft and the transmission shaft.

The propulsion mechanism optionally additionally includes a movable locking system to render the connection members integral with the transmission shaft.

According to an additional characteristic of the invention, each of the converters comprises a drive member connected to a connection member, said drive member being integral with a coupling member mounted on the transmission shaft.

Further, each of the coupling members drives the transmission shaft in one and the same direction.

Advantageously, the coupling member is a free wheel.

Further, in the known pedal assembly, the plate turns all the time, and so the pedals do as well.

That arrangement is not favorable to the efficiency of conversion of muscle energy into kinetic energy. When the cranks are on the axis of the cyclist's legs, forces applied to the pedals are inoperative.

A second aim of the present invention is also to substantially improve the efficiency of the propulsion mechanism.

According to the invention, because the stroke of the drive member is limited between an initial position and a terminal position, the converter includes a member for returning the drive member into the initial position.

In a first embodiment, the drive member is a drive plate.

As an example, the drive plate is circular.

However, preferably, the periphery of the drive plate has a distance to the axis of the plate that is continuously decreasing.

It is thus possible to optimize the efficiency of the muscular force as a function of the position of the cyclist's leg.

According to a preferential characteristic of the invention, the periphery of the drive plate has a spiral profile.

Alternatively, the periphery of the drive plate has an initial section in which its distance to the axis of that plate is increasing and a final section in which its distance to the axis of that plate is decreasing.

Here again, the supplied torque is adapted to the position of the cyclist's leg.

In a first option, the connection member is a flexible and elongate element of constant section, such as a cable or a band.

In a second option, when the periphery of the drive plate is toothed, the connection member is either a chain or a rack.

Advantageously, when the drive member is a drive plate, the return member comprises either a return plate that is integral with the drive plate, or it is a spring fixed between the rack and a fixed point.

In a first embodiment, each of the actuators comprises an adapter plate provided with a crank at the end of which is a bar, the connection member being fastened to said adapter plate.

However, the arrangement of the known pedal assembly persists essentially because of its length of service and for cultural reasons, rather than for its rational nature. It has limitations as regards conversion of the reciprocating motion of the legs into the circular motion of the transmission shaft, analogous to those of an internal combustion engine that converts the reciprocating motion of the pistons into rotary motion by means of a crankshaft.

Thus, in a second embodiment, each of the actuators comprises a bar fastened to a guide means, such that its only degree of freedom is in translation along its guide axis.

It also appears that the propulsion mechanism characterized above could be somewhat disturbing for a person who is used to a traditional pedal assembly where the two pedals are diametrically opposite, in other words in phase opposition. The fact of having two pedals that are at the same level is unusual.

As a consequence, according to a preferred characteristic of the invention, the mechanism includes a coordination means to couple the actuators so that they are moved in phase opposition.

As an example, the coordination member includes a gear.

Finally, as with a known propulsion mechanism, it may be necessary to modify the rate of rotation of the transmission shaft in order to adapt it to that of the propulsion shaft that drives the wheel or propeller.

Thus, the mechanism includes a transmission member disposed between the transmission shaft and a propulsion shaft.

The present invention is explained below in more detail in the context of the following description of an embodiment given by way of illustration and made with reference to the accompanying figures in which:

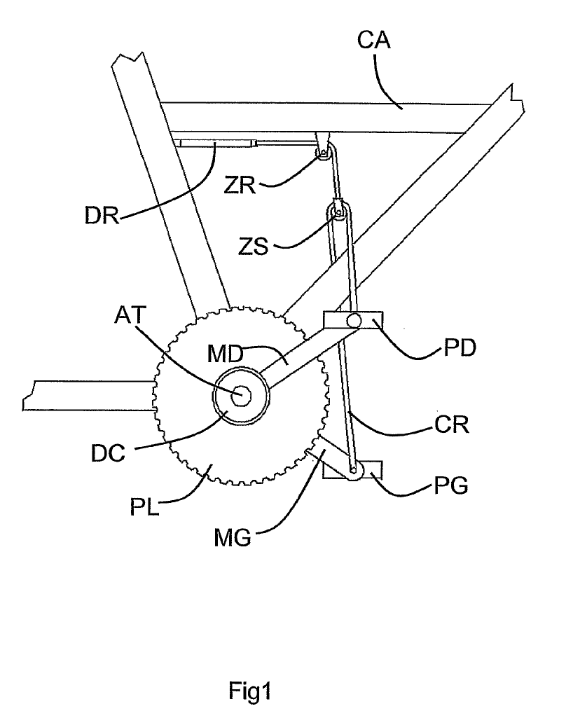

FIG. 1 is a first embodiment of the invention adapted to a bicycle;

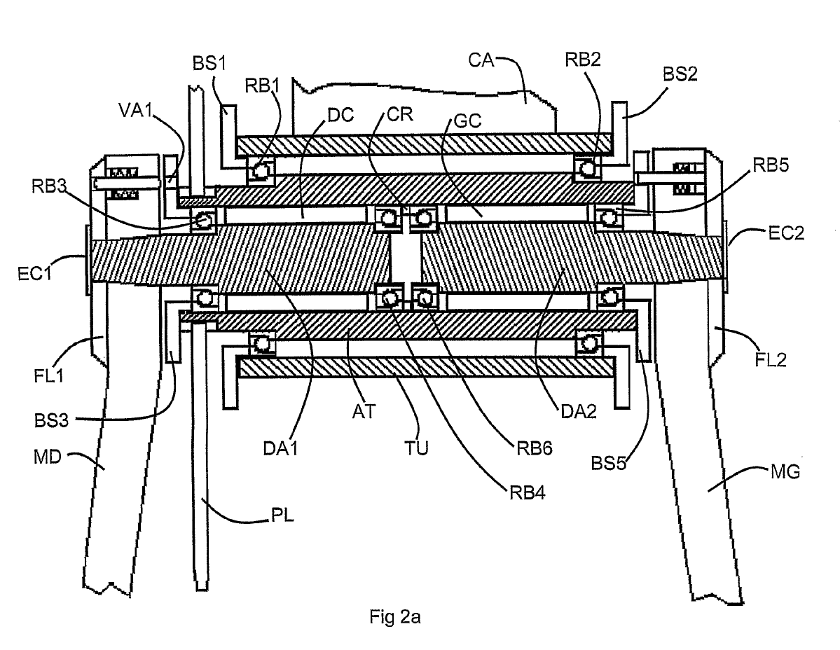

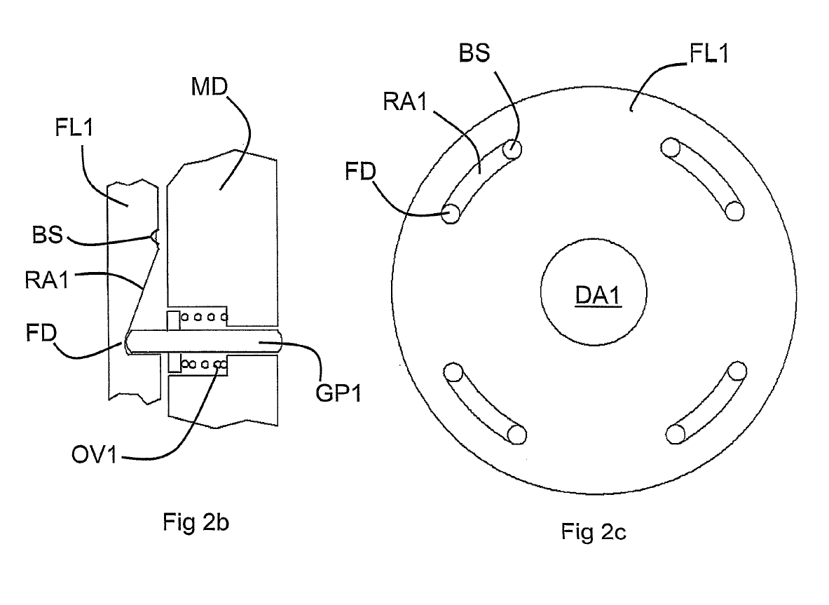

FIG. 2 is an arrangement intended for this first embodiment, more particularly:

FIG. 2a is a sectional view of a bicycle in a vertical plane integrating the median axis of the transmission shaft;

FIG. 2b is a detail of this arrangement; and

FIG. 2c is a front view of a first cheekplate;

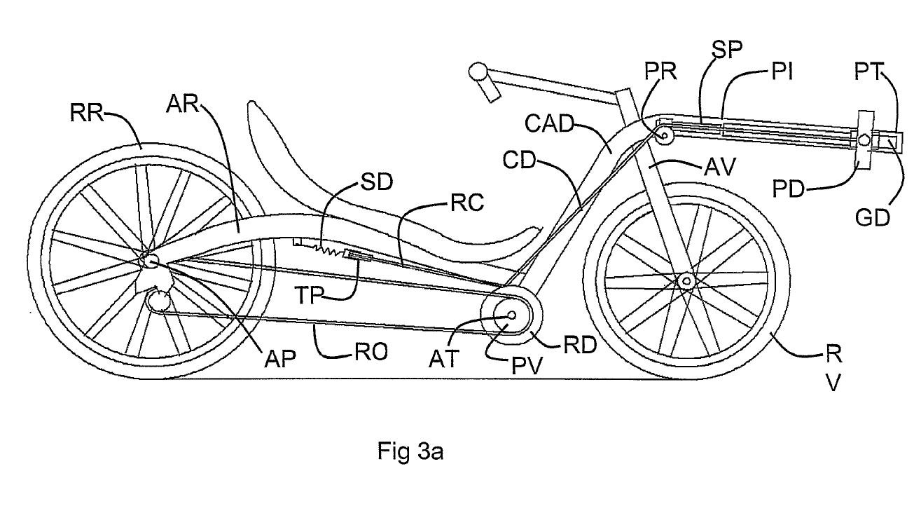

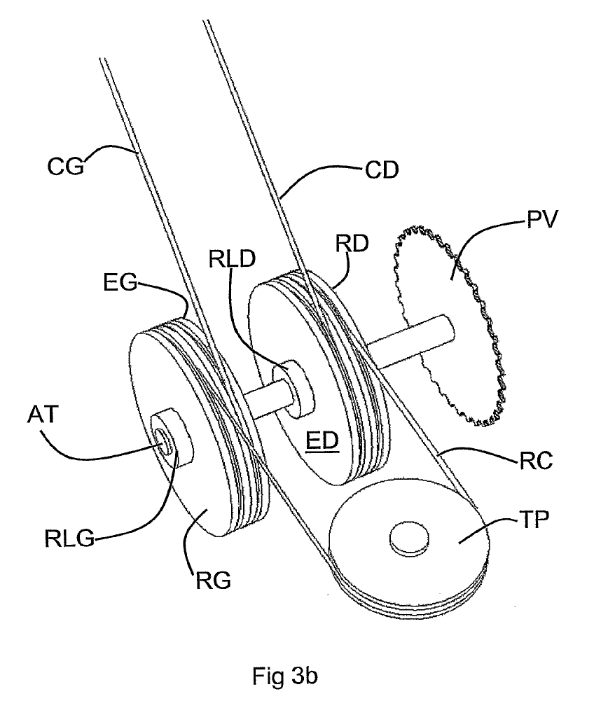

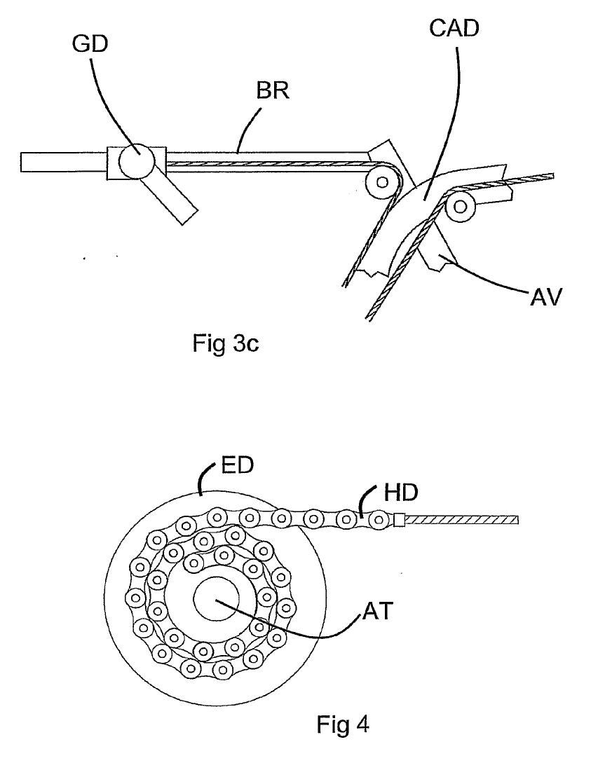

FIG. 3 is a second embodiment of the invention adapted to a “recumbent” bicycle; more particularly:

FIG. 3a is a view of the right hand side of a recumbent bicycle;

FIG. 3b is a partial perspective view of this bicycle from which the frame has been omitted; and

FIG. 3c is an enlarged view of a detail of FIG. 3a;

FIG. 4 is a first type of drive member;

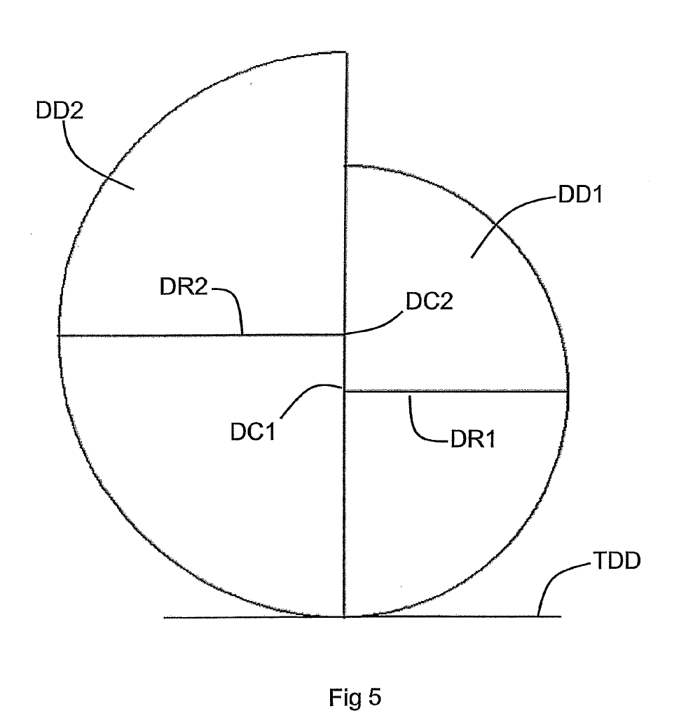

FIG. 5 is a second type of drive member;

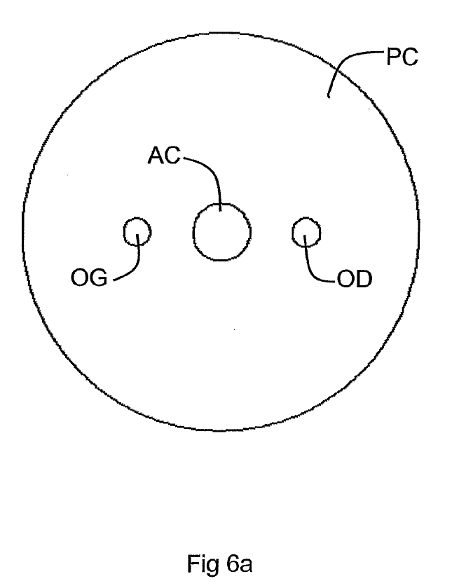

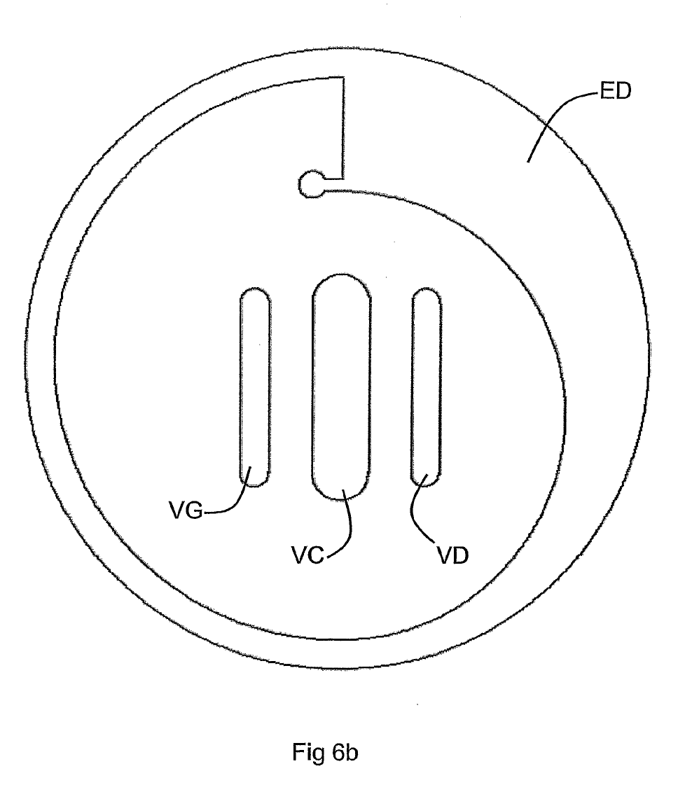

FIG. 6 is an arrangement intended to modify the position of the drive member; more particularly:

FIG. 6a is an adapter member; and

FIG. 6b is a variation of a drive member provided to cooperate with said adapter member;

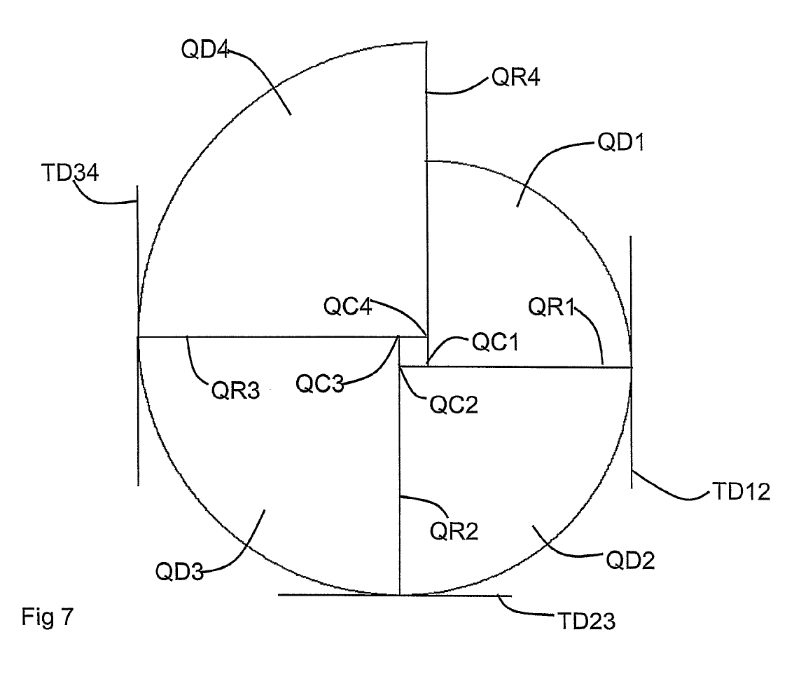

FIG. 7 is a third type of drive member;

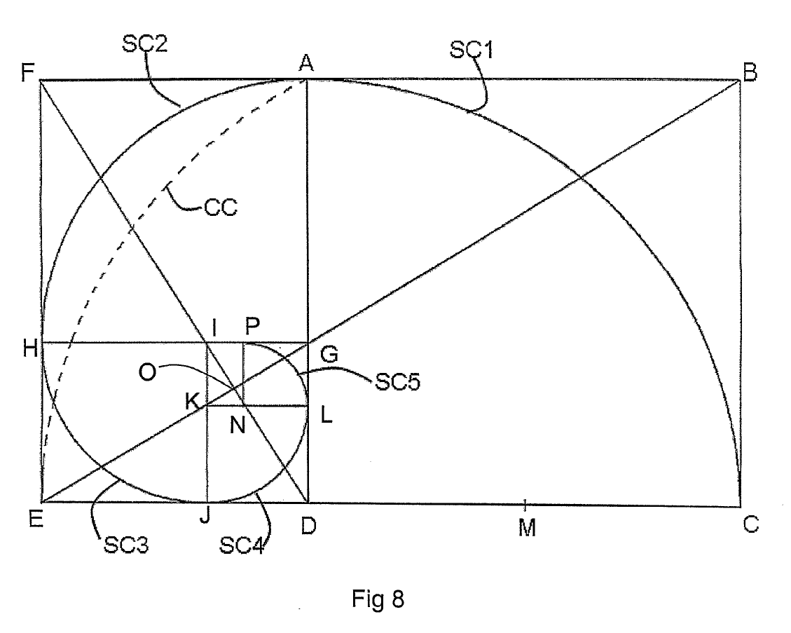

FIG. 8 is a fourth type of drive member;

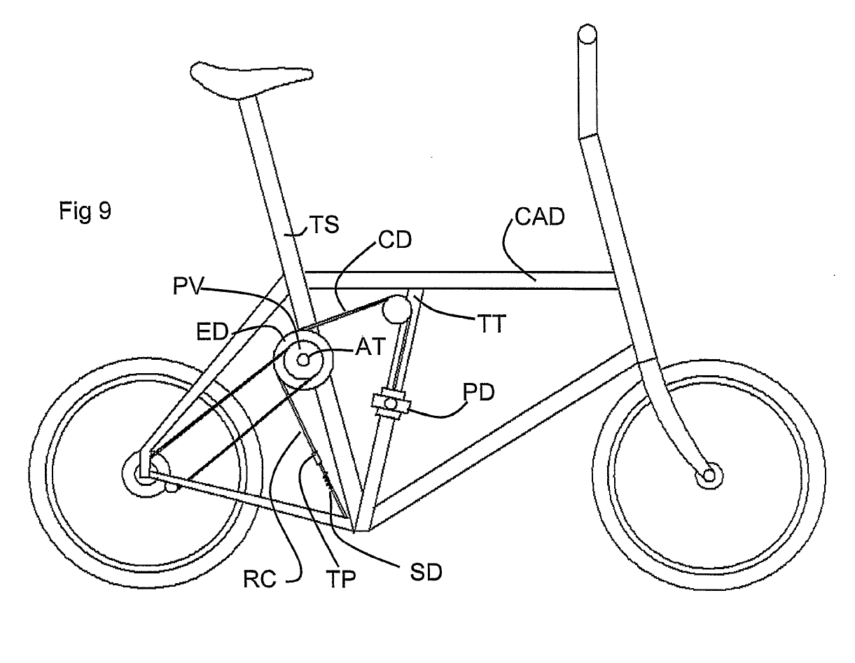

FIG. 9 is an arrangement of a propulsion mechanism on a mountain bike;

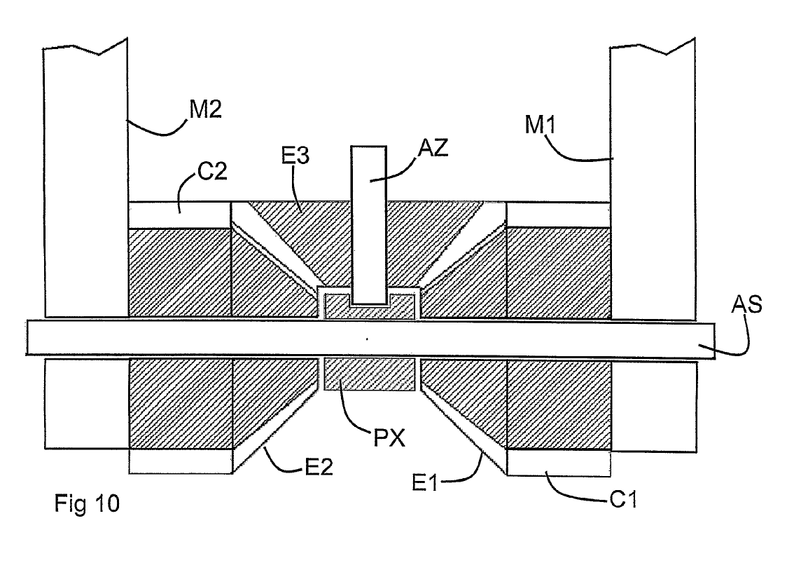

FIG. 10 is a coordination member;

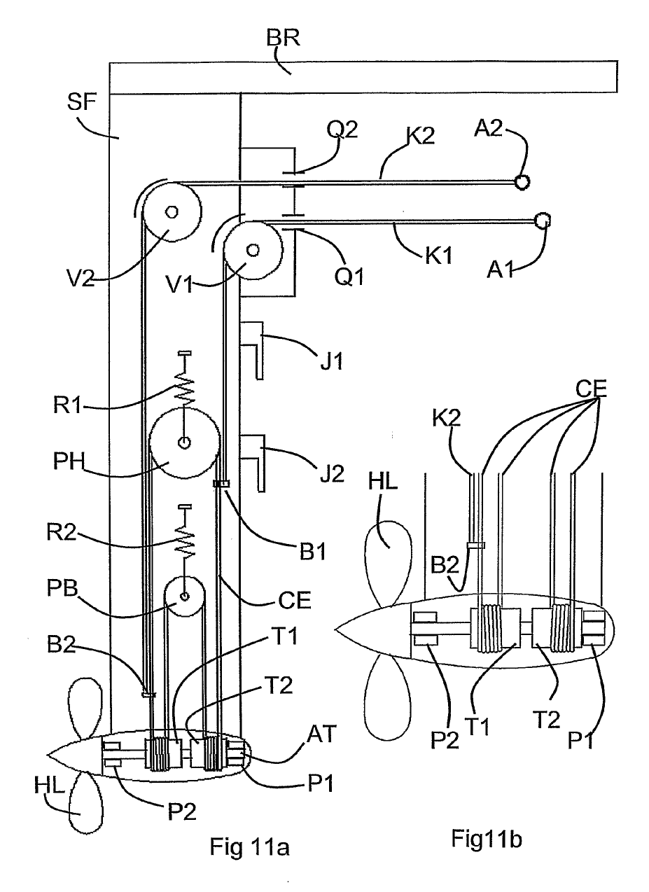

FIG. 11 is an embodiment of the invention adapted to a boat; in particular:

FIG. 11a is a propulsion mechanism mounted on a rudder blade; and

FIG. 11b is an enlarged view of this mechanism at the propulsion screw;

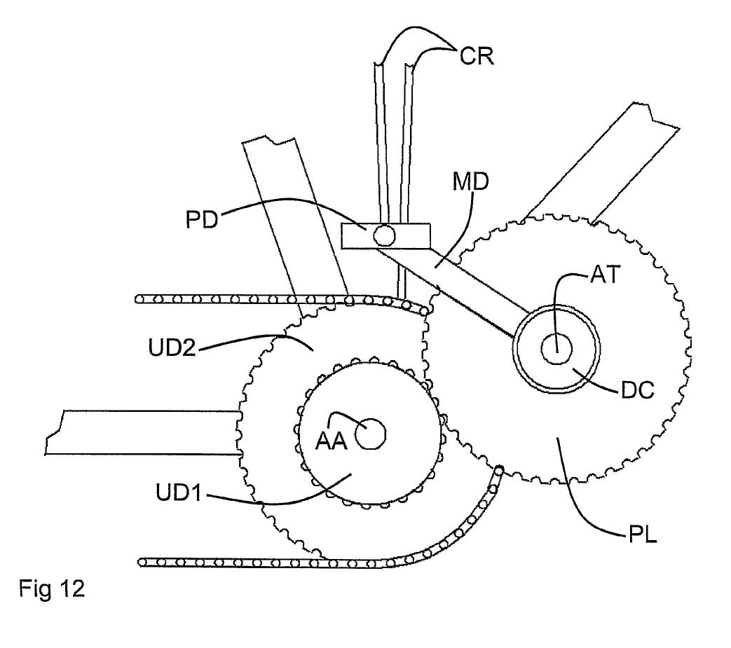

FIG. 12 is a variation of the first embodiment of the invention adapted for a bicycle.

Identical elements that are present in more than one of the figures are given the same references.

Referring to FIG. 1, a propulsion mechanism is shown on a regular bicycle. As mentioned above, this mechanism is readily adaptable by the skilled person to numerous other types of vehicle.

The bicycle essentially comprises a frame CA that supports a transmission shaft AT on which a traditional pedal assembly is normally mounted, but here it is equipped with a mechanism that can overcome the above-described limitations of such a pedal assembly.

A first actuator is constituted by a pedal, the right pedal PD that is connected to a first converter by means of a first connection member, which here takes the form of a crank, the right crank MD. The first converter comprises a first coupling member DC that is firstly mounted on the transmission shaft AT, and that is secondly rigidly connected to the right crank MD. The function of this coupling member is to transmit the rotational motion of the crank MD to the transmission shaft in a single direction, here the clockwise direction.

A free wheel is entirely appropriate for this function.

It is preferable to cause the right pedal to return automatically from the position where the leg is extended to the position when the leg is bent. This thus avoids using devices of the toe-clip or automatic pedal type.

A first return element DR here takes the form of a bungee cord or a spring attached via its first end to a fixed point, on the seat tube, for example. This return element passes over a guide pulley ZR mounted on the top tube of the frame CA and its second end supports a suspended pulley ZS about which a cord CR is wound. The cord CR connects the left MG and right MD cranks close to their ends opposite to those that are mounted on the transmission shaft AT. Naturally, said bungee cord DR tends to make the right crank MD rotate in the anticlockwise direction. The skilled person may envisage a plurality of variations of this return means, given here purely by way of example.

A transmission member is provided to transmit the motion of the transmission shaft AT to the propulsion shaft that is integral with the hub of the rear wheel. As is usual, this member takes the form of a toothed sprocket plate PL.

A second actuator is constituted by the left pedal PG that is connected to a second converter by means of a second connection member MG which is here constituted by the left crank MG.

This crank MG is integral with a second coupling member, namely a second free wheel also mounted on the transmission shaft AT.

It is possible to transform the pedal assembly described above to return to a traditional pedal assembly by means of a locking system.

A first solution consists in locking the free wheels when the two pedals PD, PG are diametrically opposed.

A second solution consists in locking the cranks MD, MG on the transmission shaft AT using a key type device.

A third solution consists in locking the right crank MD on the sprocket plate PL, adding a plate that is integral with the transmission shaft close to the left crank MG and securing these two latter elements to each other.

FIG. 2 shows a section of the bicycle at right angles to a vertical plane passing via the median axis of the transmission shaft AT, as a modification to a traditional pedal assembly casing, which means that the present invention can be used in a small space.

This casing is integrated into a cylindrical tube TU fixed on the frame CA at the junction of the seat tube and the down tube.

The transmission shaft AT here is a hollow shaft with each of its two ends having a shoulder and being internally threaded. This shaft AT is mounted in the cylindrical tube TU by means of a first RB1 and a second RB2 angular contact ball bearing.

The first ball bearing RB1 disposed on the side of the right crank MD bears on the corresponding shoulder of the cylindrical tube TU and is held in position by a first clamping collar BS1 having an external thread that cooperates with the internal thread of the tube TU.

Similarly, the second ball bearing RB2 disposed on the side of the left crank MG bears on the corresponding shoulder of the cylindrical tube TU and is held in position by a second clamping collar BS2 having an external thread that cooperates with the internal thread of the tube TU.

The sprocket plate PL is rigidly connected to the transmission shaft AT on the right crank MD side.

A first half-axle DA1 supports the right crank MD at its first end. Its second end is introduced into the transmission shaft AT and the first coupling member DC is inserted between this shaft and said half-axle DA1.

Either side of the first coupling member DC are shoulders on which third RB3 and fourth RB4 angular contact ball bearings are respectively located on the side of the right crank MD and at the center of the cylindrical tube TU will bear.

The third ball bearing RB3 is held by a third clamping collar BS3 having an external thread that cooperates with a female thread provided in the transmission shaft AT.

The fourth ball bearing RB4 bears on a plug washer CR.

The right crank MD is push fitted onto the first end of the first half-axle DA1 that has a square-based pyramidal section. It is held by a first circular cheekplate FL1 which itself is held on the half-axle DA1 by any means such as a first nut EC1.

Apart from the sprocket plate PL, the bicycle is symmetrical relative to the median plane of the frame CA.

Thus, a second half-axle DA2 supports the left crank MG at its first end. Its second end is introduced into the transmission shaft AT and the second coupling member GC is inserted between said shaft and said half-axle DA2.

Either side of the second coupling member GC are shoulders on which bear a fifth RB5 and a sixth RB6 angular contact ball bearing respectively located on the side of the left crank MG and at the center of the cylindrical tube TU.

The fifth ball bearing RB5 is held by a fifth clamping collar BS5 having an external thread that cooperates with a female thread provided in the transmission shaft AT.

The sixth ball bearing RB6 bears on the plug washer CR.

The left crank MG is push fitted onto the first end of the second half-axle DA2. It is held by a second cheekplate FL2 that is itself held on the half-axle DA2 by a second nut EC2.

It is also possible to revert to a traditional pedal assembly.

To this end, a first axial cavity VA1 opening at least on the side of the right crank MD is provided in the third clamping collar BS3.

Referring also to FIGS. 2b and 2c, a first opening OV1 passes from one side to the other of the right crank MD along an axis that is parallel to that of the transmission shaft AT. This opening OV1 coincides with the first axial cavity VA1 to a predetermined angular position, below the locking position, of said crank MD.

In this first opening OV1 is housed a first pin GP1 provided with a spring that tends to urge it against the first cheekplate FL1.

This first cheekplate FL1 is provided with a first ramp RA1 that extends from its base FD to a dimple BS located substantially on the cheekplate face that faces the right crank.

When the first pin GP1 bears on the base FD of the ramp RA1, it is flush with the face of the right crank MD that faces the third clamping collar BS3 and thus it cannot engage in the first axial cavity VA1.

In contrast, in the locking position, it is possible to pivot the first cheekplate FL1 mounted with clearance on the first half-axle DA1 to cause the pin GP1 to rise up the ramp RA1 and engage in the dimple BS. In this position, the first pin GP1 projects from the right crank MD and is introduced into the first axial cavity VA1. This crank is then rendered integral with the transmission shaft AT.

Naturally, a plurality of angularly distributed pins can be provided, as can be seen in FIG. 2c.

Identical means are provided for the left crank MG, and thus they are not described.

Referring now to FIGS. 3a and 3b, a propulsion mechanism is shown on a bicycle that can be used in the so-called “recumbent” position. The “recumbent” bicycle is used here since it provides a particularly good illustration of the performance that this mechanism can attain.

The bicycle essentially comprises a frame CAD, having a front fork AV and a rear fork AR mounted thereon that are respectively provided for fixing a front wheel RV and a rear wheel RR.

A first actuator, the only one shown in FIG. 3a, is constituted by a bar PD fastened to any guide means GD. In this example, the bar is termed the pedal since it is intended to be actuated by the right foot of a cyclist, but it could also be a handle or a lever if it is intended to be actuated using the hand. The guide means GD may take the most diverse of forms; a linear guiding system has been used here. The bar PD is thus mounted on a carriage that is engaged in a linear guide means such as a groove or a rail so that the only movement which it can make is translation coaxial with the axis of this rail. The term “linear guide” does not necessarily mean guiding rectilinearly; the axis of the rail may follow any curve such as an arc of a circle. This first actuator PD is connected to a first converter by means of a first connection member CD which here is in the form of a cable. This cable CD passes over an adjustment pulley PR that can be moved on a support SP fixed to the frame. The function of this pulley is described below.

The first converter comprises a first drive member ED, a pulley in the present example, that is integral with a first coupling member RLD mounted on the transmission shaft AT. The function of this coupling member is to transmit the rotary motion of the pulley ED to the transmission shaft in a single direction, here clockwise.

A free wheel is thus entirely appropriate for this function.

When the cyclist's leg is in extension, the terminal position PT of the pedal PD shown in the figures, it is preferable to cause it to return automatically to its initial position PI when the cyclist's leg is bent. Thus, the use of toe-clip or automatic pedal type devices is avoided.

A first return member is here in the form of a first return pulley RD that is integral with the first drive member ED. A connection cable RC is wound on this first return pulley RD and is fixed thereon at its first end. Said cable RC then passes into a tension pulley TP and the fixing of its second end is explained below. The tension pulley TP is connected to the rear fork AR via a spring or a bungee cord SD.

Naturally, said bungee cord SD tends to make said return pulley turn in the anticlockwise direction. The skilled person can envisage many variations of this return means that has been given here purely by way of example. It should be noted that the return pulley RD may be limited to a simple ring juxtaposed with the drive member and having the same axis or, in contrast, that the drive member consists of a ring juxtaposed with the return pulley.

A transmission member is provided to transmit the motion of the transmission shaft AT to the propulsion shaft AP that is integral with the rear wheel means RR. Here, this member comprises a front sprocket PV that is integral with the transmission AT, a rear sprocket integral with the propulsion shaft AP, and a transmission chain RO to inter-connect these two sprockets.

Regarding the drive member, here the drive plate ED, its shape needs to be defined.

The first idea that comes to mind is to adopt a circular shape. This known shape is appropriate when a screw propeller is to be driven, but it is not optimized, however, for converting the muscular force of a cyclist.

It is in fact preferable to provide a smaller force when the leg is bent.

To this end, it may be provided that the distance from the connection member CD to the axis of the transmission shaft AT decreases as the actuator PD is moved from its initial position PI to its terminal position PT, that distance being taken from the point at which the connection member CD leaves the drive plate ED.

Referring now to FIG. 4, a first solution consists in taking a connection chain as the connection member HD. The thickness of this chain means that its distance to the transmission shaft AT increases as it winds up on the drive plate ED. The means for acting on the rate of increase of this distance is, however, limited since the only parameter that is in play is the thickness of the chain. The core of this plate is the origin of an “Archimedes” spiral.

In general, a spiral is defined in polar coordinates by its radius R as a function of the angle α: R=f(α). Preferably, the function f is continuous, as is its derivative.

The simplest function is a constant function R=R₀, which corresponds to a circle with radius R₀.

The Archimedes spiral follows a regular progression with R=c·α, where c, its derivative, is a constant. Mechanically constructing such a spiral is difficult, but it is possible to provide an approximate representation using an “n-center” spiral where n is an integer.

The n-center spiral is constituted by producing a succession of circular arcs connected by respective tangents that are common at their junction.

Referring now to FIG. 5, a two-center spiral is constructed by taking a first half-disk DD1 with center DC1 and radius DR1 and superimposing along its diameter a second half-disk DD2 with center DC2 and radius DR2 such that these two half-disks have a common tangent TDD. Several configurations can be distinguished, depending on the position of the transmission shaft relative to the centers DC1, DC2 of the two half-disks DD1, DD2. This shaft that is perpendicular to the spiral is preferably disposed on the common diameter of the two half-disks.

When the shaft is disposed between the center DC1 of the first half-disk DD1 and the junction point of the two half-disks on their common tangent TDD, if the spiral turns in the clockwise direction, its radius at its highest point decreases up to the junction point of the two half-disks DD1, DD2 and then increases.

When the shaft is disposed at the center DC1 of the first half-disk, the radius of the spiral at its highest point decreases to the junction point of the two half-disks and is then constant.

When the shaft is disposed between the centers DC1, DC2 of the two half-disks, the radius of the spiral decreases constantly as it carries out a complete turn.

When the shaft is disposed at the center DC2 of the second half-disk, the radius of the spiral is constant for half a turn and then decreases.

When the shaft is disposed between the center DC2 of the second half-disk and the detachment point of the two half-disks, the radius of the spiral increases to the junction point of the two half-disks on their common tangent TDD, and then decreases.

It should be noted that the spiral will generally have its largest radius at the start of the stroke (bent leg position) and its smallest radius at the end of the stroke (extended leg position).

As described above, it is possible, at the start of the stroke, to have a radius that decreases regularly to a constant value for the end of the stroke. In this configuration, the start of the stroke is good for acceleration, and the end of the stroke is good for maintaining speed.

It is also possible for the start of the stroke to be good for acceleration with the end of the acceleration stroke being less marked.

Referring now to FIG. 6a, the invention can be used to vary the position of the spiral relative to the transmission shaft using an adapter member that can modify the arrangement of the drive member in the converter.

To this end, a coupling plate PC is provided that is integral with the coupling member by means of a central bore AC. Either side of this bore AC, a right orifice OD and a left orifice OG are provided. The coupling plate PC may be coincident with the first return member (the first return pulley RD in FIG. 3b).

Referring now to FIG. 6b, the drive plate ED is mounted on the coupling plate PC.

To this end, the drive plate ED is provided with three oblong recesses, a central VC, a right VD and a left VG, which respectively correspond to the central bore AC, the right orifice OD and the left orifice OG of the drive plate ED.

Thus, the central recess VC will accommodate the coupling member and the drive plate ED can slide on the coupling plate PC. Once the relative position of these two plates is suitable, they are fixed by means of any device, for example two butterfly screws one of which passes through the left recess VG and the orifice OG and the other via the right recess VD and orifice OD.

Referring now to FIG. 7, a four-center spiral is constructed, commencing by producing a first quarter disk QD1 (quarter in top right of figure) with center QC1 and radius QR1.

A second quarter disk QD2 (quarter at bottom right in figure) with center QC2 and radius QR2 is juxtaposed with the first quarter disk QD1 so that these two quarter disks have a common tangent TD12. The difference between the two radii, QD2-QD1, is equal to an incremental constant a.

A third quarter disk QD3 with center QC3 and radius QR3 is juxtaposed with the second quarter disk QD2 so that these two quarter disks have a common tangent TD23. The difference between the two radii, QR3-QR2, is again equal to the incremental constant a.

A fourth quarter disk QD4 with center QC4 and radius QR4 is juxtaposed with the third quarter disk QD3 so that these two quarter disks have a common tangent TD34. The difference between the two radii, QR4-QR3, is again equal to the incremental constant a. Naturally, the first QD1 and fourth QD4 quarter disks are connected.

Ideally, the transmission shaft is centered on the square formed by the four centers QC1, QC2, QC3 and QC4.

It is possible to substantially increase the amplitude between the extreme radii of the spiral by adopting, rather than a linear function, a logarithmic function of the angle α as a function of the radius R:

R=c·exp(kα)

where c and k are two constants.

Such a spiral may also be approximated by a geometric function termed a “gold spiral” resulting from the juxtaposition of circular sectors.

Referring now to FIG. 8, the starting point is a first square ABCD, M being the middle of the lower side CD of said square.

A first circular sector SC1 is the quarter circle with center D and radius DC defined by the points C and A. It is then necessary to construct a circular arc CC with center M and radius MA which cuts the extension of the lower side CD to the side of point D at a point E.

The point F is obtained by forming a first rectangle FBCE; the two adjacent sides are BC and CE.

The diagonal BE of the first rectangle FBCE cuts AD at a point G and the point H is obtained by producing the orthogonal projection of this point G on the side FE.

A second circular sector SC2 is the quarter circle with center G and radius GA defined by the points A and H.

The diagonal FD of the second rectangle FADE cuts GH at a point I and the point J is obtained by forming the orthogonal projection of this point I on the side DE.

A third circular sector SC3 is the quarter circle with center I and radius IH defined by the points H and J.

The diagonal EG of the third rectangle HGDE cuts IJ at K and the point L is obtained by forming the orthogonal projection of this point K on the side DG.

A fourth circular sector SC4 is the quarter circle with center K and radius KL defined by the points J and L.

The diagonal ID of the fourth rectangle cuts KL at N and the point P is obtained by forming the orthogonal projection of this point N on the side GI.

A fifth circular sector SC5 is the quarter circle with center N and the radius NL defined by the points L and P.

The spiral CAHJLP is thus constituted by the succession of five circular sectors SC1 to SC5. Ideally, the transmission shaft is centered on the point of intersection O of the diagonal BE of the first rectangle and the diagonal FD of the second rectangle.

It should be noted that this spiral develops over close to 450°, i.e. a little more than a full turn. If this development proves to be insufficient, it is possible to make several turns by winding up superimposed or juxtaposed spirals on a drum.

It is also possible to construct a helix based on a spiral: in the direction Oz normal to the plane Oxy of the spiral, the Z coordinate along this axis Oz is Z=p·α, p being a constant; at the end of one turn, the offset along the axis Oz of two points separated by 360° must be at least equal to the width of the connection element.

Several arrangements may be provided for the propulsion mechanism.

The first drive member ED may take the form of a sprocket plate rather than a pulley. The first connection member is then either a chain as mentioned above or a rack in direct contact with the plate. The first actuator is integral with the rack.

Further, when the drive member is not circular in shape, it may be judicious to use just one portion of the total angular travel of that member. This is the primary function of the adjustment pulley PR mentioned above which, as a function of its position on the support SP, modifies the length of the connection member CD included between the initial position PI and the drive member ED. For a reference position for the first actuator PD in the guide means GD, the initial position PI, for example, the first actuator is brought into the required position by moving the adjustment pulley PR.

The propulsion mechanism of the present invention is substantially symmetrical apart from having a single front sprocket PV.

Thus, referring now to FIG. 3b, on the left side of the bicycle, a second actuator, like the first, is constituted by a bar fastened to a guide means. This second actuator is connected to a second converter by means of a second connection means CG. The second converter comprises a second drive member EG, here a pulley, that is integral with a second coupling member mounted on the transmission shaft AT. Here again, the function of said coupling member is to transmit the rotational motion of the pulley EG to the transmission shaft in a single direction.

A second return member takes the form here of a second return pulley RG that is integral with a second drive member EG, a return pulley on which the connection cable RC winds being fixed to its second end.

Although in most circumstances the two drive members ED, EG are identical, it is not vital here for carrying out the invention. In contrast, it is possible to adapt these members to a certain lack of symmetry in the user of the bicycle.

Further, the skilled person understands that it is possible to arrange additional converters on the transmission shaft these being, for example, actuated by the hands. Thus, referring to FIG. 3c, it is possible to provide a handle type actuator mounted, like one of the pedals, on the horizontal arm BR of the seat tube. This actuator here is the guide GD which slides on the arm BR. It is also possible to provide two independent actuators mounted on this same arm. This type of arrangement is particularly well suited to handicapped persons who cannot propel themselves with their legs.

Naturally, the propulsion mechanism is suitable for a traditional transmission with gears in which there is only one front sprocket and a rear sprocket but where an assembly of two or three integral plates is provided in place of the front sprocket and a cage provided with a plurality of sprockets in place of the rear sprocket. In this configuration, it is not necessary to provide a free wheel in the cage. It follows that it is no longer necessary to pedal to change the gears using front and rear derailleurs, provided that the bicycle is moving forwards.

An additional advantage of the invention becomes clear when the actuators are not rigidly connected to the transmission shaft. It is thus possible to reorganize the entire drive system. On a traditional bicycle, the pedal assembly placement is imposed, which limits the ground clearance. Although it is not really a problem for urban use, this limitation may be very severe for mountain or trial use.

Referring now to FIG. 9, the first linear guiding actuator PD is disposed on a cross bar TT fixed between the top tube and the base of the frame CAD.

The transmission shaft AT and all of the elements is supports, in particular the first drive member ED and the front sprocket PV, is fixed on the seat tube TS.

Further, it should be recognized that the mode of use of the present propulsion mechanism could disorientate a cyclist who was accustomed to a traditional pedal assembly whereby the two pedals are permanently diametrically opposed.

Thus, referring now to FIG. 10, we provide a coordination member to ensure the movement of the actuators in the reverse direction. A first pedal type rotary actuator is mounted on a first crank M1 that is free to turn about a support axis AS. Similarly, a second rotary actuator is mounted on a second crank M2, which is also free to turn about the support axis AS.

A first ring C1 that is integral with the first crank M1 and faces the second crank M2 is provided on its left flank with a 45° gear E1. At the same time, a second ring C2 that is integral with the second crank M2 and faces the first ring M1 is provided on its right flank with a 45° gear E2.

A third gear E3 is loose mounted on a transverse axis AZ that is perpendicular to the support axis AS. It is in engagement with the first E1 and second E2 gears. In addition, a bearing PX is provided to hold both the support axis AS and the transverse axis AZ.

The propulsion mechanism presented above is not limited to terrestrial use; we shall now present an adaptation for a boat.

Referring now to FIGS. 11a and 11b, the mechanism is fixed on a rudder plate SF provided with a bar BR and two pintles J1, J2 for fixing to the stern of the boat.

The first and second actuators (not shown) are connected to a first and a second connection member (also not show) of the wire type that are respectively connected to a first ring A1 and a second ring A2.

The transmission shaft AT on which the propeller screw HL is mounted is fixed to the base of the rudder plate SF by a first bearing P1 and second bearing P2. A first drum T1 and a second drum T2 are mounted side by side via a first and a second free wheel on said transmission shaft AT.

An upper pulley PH is suspended via a first spring R1 on the rudder plate SF. A lower pulley PB is also fixed on the rudder plate below the preceding one via a second spring R2.

A looped drive cable CE is wound around the upper pulley PH. Starting from this pulley, it is wound in the forward direction on the first drum T1, passes around the lower pulley PB and is wound around the second drum T2 in the reverse direction before returning to the upper portion PH.

A first collar B1 is fixed on the drive cable CE between the upper pulley PH and the first drum T1. Similarly, a second collar B2 is fixed on that same cable CE between the upper pulley PH and the second drum T2.

A first return cable K1 has its first end fixed to the first collar B1, passes over a first return pulley V1, and is finally fixed to the first ring A1. Similarly, a second return cable K2 has its first end fixed to the second collar B2, passes over a second return pulley V2 and is finally fixed on the second ring A2.

The reader should understand that it is sufficient to connect the rings A1, A2 to any actuators, for example one or other of those presented above with reference to the bicycle.

This particular arrangement has the advantage of meaning that the rudder plate SF can be removed from the boat, leaving the actuator assembly in place therein.

The wire guides Q1, Q2 guide the return cables K1, K2 and prevent the rings A1, A2 from penetrating into the mechanism. The two-pulley system PH, PB guarantees that the drive cable CE is permanently under tension. This prevents it from leaving the drums T1, T2 and winding itself around the transmission shaft AT. Further, a clevis is provided on each of the return pulleys V1, V2 to prevent the return cables K1, K2 from leaving the grooves of these pulleys.

The skilled person can readily transpose the adaptation of the above mechanism to the propulsion of an aircraft, making only a few minor changes.

The important point is to define the diameter of the drums T1, T2 as a function of the stroke of the return cables K1, K2 and the frequency of stressing the actuators in order to obtain the required rotation rate for the transmission shaft.

Regardless of the vehicle on which it is used, the invention can also modify the conversion ratio between the rotational speeds of the transmission shafts and the propulsion shafts, both in sign and absolute value.

To this end, considering FIG. 12, a variation of the first implementation described with reference to FIG. 1 incorporates a conversion module.

Thus, the sprocket plate PL integral with the transmission shaft AT can be seen as well as the right crank MD mounted on this shaft via the first free wheel DC.

However, it should be noted that the pedals are thus arranged so that they are constantly between the transmission and propulsion shafts. This avoids the risk of them obstructing pivoting of the front wheel when changing direction. It follows that the transmission shaft AT turns in the anticlockwise direction, i.e. in the direction contrary to the direction of rotation required for the propulsion shaft.

The conversion module is freely mounted on an auxiliary axis AA that is fixed on the frame of the bicycle.

This module comprises an integral first, UD1, and second, UD2, toothed coaxial wheel.

The first toothed wheel UD1 meshes with the sprocket plate PL, so that it turns in the clockwise direction like the second toothed wheel UD2. This toothed wheel UD2 supports the chain provided to drive the propulsion shaft.

Thus, the conversion module reverses the direction of rotation of the transmission shaft and modifies the conversion ratio in proportion to the diameters or the number of teeth on the two toothed wheels UD1, UD2.

The examples of the invention presented above have been selected because of their concrete nature. It would not be possible to provide an exhaustive itinerary of all of the embodiments encompassed by the invention. In particular, any means may be replaced by an equivalent means without departing from the spirit and scope of the invention.

1. A propulsion mechanism comprising a first actuator connected via a first connection member to a first converter mounted on a transmission shaft, characterized in that it comprises a second actuator that is connected via a second connection member to a second converter mounted on said transmission shaft.

2. A mechanism according to claim 1, characterized in that, since it is provided in order to drive a propulsion shaft, it comprises a conversion module to reverse the direction of rotation of said propulsion shaft relative to that of said transmission shaft.

3. A mechanism according to claim 1, characterized in that, since it is provided in order to drive a propulsion shaft, it comprises a conversion module to modify the ratio of the rotational speeds of said propulsion shaft and of said transmission shaft.

4. A mechanism according to claim 1, characterized in that it comprises a movable locking system to fix said connection members to said transmission shaft.

5. A mechanism according to claim 1, characterized in that each of the converters comprises a drive member connected to said connection member, said drive member being integral with a coupling member mounted on said transmission shaft.

6. A mechanism according to claim 5, characterized in that each of said coupling members drives said transmission shaft in a single direction.

7. A mechanism according to claim 6, characterized in that said coupling member is a free wheel.

8. A mechanism according to claim 5, characterized in that when said drive member has a limited stroke between an initial position and a terminal position, said converter comprises a return member for returning said drive member into said initial position.

9. A mechanism according to claim 5, characterized in that said drive member is a drive plate.

10. A mechanism according to claim 9, characterized in that said drive plate is circular.

11. A mechanism according to claim 9, characterized in that the periphery of said drive plate has a distance to the axis of said plate that is continuously decreasing.

12. A mechanism according to claim 11, characterized in that said periphery of the drive plate follows a spiral profile.

13. A mechanism according to claim 9, characterized in that the periphery of said drive plate has an initial section in which its distance to the axis of said plate is increasing and a final section in which its distance to the axis of said plate is decreasing.

14. A mechanism according to claim 9, characterized in that said connection member is a flexible elongate element with a constant section.

15. A mechanism according to claim 9, characterized in that when the periphery of said drive plate is toothed, said connection member is a chain.

16. A mechanism according to claim 9, characterized in that when the periphery of said drive plate is toothed, said connection means is a rack.

17. A mechanism according to claim 8, characterized in that when said drive member is a drive plate, said return member comprises a return plate that is integral with said drive plate.

18. A mechanism according to claim 16, characterized in that said return member is a spring fixed between said rack and a fixed point.

19. A mechanism according to claim 1, characterized in that each of said converters comprises an adapter plate, said connection member being fastened to said adapter plate.

20. A mechanism according to claim 1, characterized in that each of said actuators comprises a bar fastened to a guide means, so that its only degree of freedom is translation along its guide axis.

21. A mechanism according to claim 1, characterized in that it comprises an adjustment member to adjust the arrangement of said connection members so that a reference position for said actuators corresponds to a required position for said converters.

22. A mechanism according to claim 1, characterized in that it comprises a coordination member to couple said actuators so that they are moved in phase opposition.

23. A mechanism according to claim 22, characterized in that said coordination member comprises a gear.

24. A mechanism according to claim 1, characterized in that it comprises a transmission member disposed between said transmission shaft and a propulsion shaft.
